(19) United States
(12) Patent Application Publication
(10) Pub. No.: US 2013/0205282 A1
(43) Pub. Date: Aug. 8, 2013

(54) TRANSFERRING PROGRAM EXECUTION FROM COMPILED CODE TO INTERPRETED CODE

(71) Applicants: Louis Lafreniere, Seattle, WA (US); Curtis Man, Seattle, WA (US)

(72) Inventors: Louis Lafreniere, Seattle, WA (US); Curtis Man, Seattle, WA (US)

(73) Assignee: MICROSOFT CORPORATION, Redmond, WA (US)

(21) Appl. No.: 13/368,330

(22) Filed: Feb. 7, 2012

(51) Int. Cl. G06F 9/45

(52) U.S. Cl. 717/139

(57) ABSTRACT

Optimized compiled code can be generated from bytecode derived from a program written in a dynamic language such as JavaScript. Optimizations can be based on one or more assumptions. During execution of the optimized compiled code, the assumption or assumptions on which the optimization was based can be examined for validity. In response to determining that the optimization was based on an invalid assumption or assumptions, execution of the optimized code can stop, the state of variables used by an interpreter can be restored and execution of the program can resume in the interpreter using the unoptimized bytecode derived from the program. Resumption of the program can resume at the point in the bytecode analogous to the point in the optimized compiled code at which the assumption or assumptions was determined to be false.

### BACKGROUND

A dynamic programming language is one that at runtime executes behaviors that a static language typically performs during compilation or not at all. The behaviors executed at runtime by a dynamic language can include extension of the program by adding new code, by extending objects and definitions, or by modifying the type system. In a dynamic programming language, information not available at compile time can significantly alter how the program executes. For example, in a static program, when a variable is declared in the source code, the declaration specifies the type of the variable: variable x is an integer, or variable x is a string, etc. If variable x is an integer, adding x to an integer constant will perform an arithmetic add. If variable x is a string, adding x to a constant that is a string will perform a concatenation of the constant and x. In a dynamic programming language, the type of the variable is not known until the program executes, so additional code paths are needed to handle the different types of operations that can occur, adding overhead to program execution.

Examples of languages generally considered to be dynamic languages include but are not limited to: ActionScript, BASIC, BeanShell, ColdFusion, Common Lisp and some other Lisp languages, Groovy, E programming languages; JavaScript, VBScript, MATLAB, Lua, Objective-C, Perl, PHP, Powershell, Python, Ruby, Smalltalk, Tel and Dolphin Smalltalk.

### SUMMARY

With dynamic languages, assumptions can be made about type information which is not possible to determine statically. Optimizations can then be applied using this imprecise information. A fallback or bailout mechanism triggered by invalidation of an optimization assumption can be provided. Optimized compiled code can be generated from bytecode derived from a program written in a dynamic language such as but not limited to JavaScript. Optimizations can be based on one or more assumptions about characteristics of the data. During execution of the optimized compiled code, the assumption or assumptions on which the optimization was based can be examined for validity. In response to determining that the optimization was based on an invalid assumption or assumptions, execution of the optimized code can stop, the state of corresponding variables used by an interpreter can be restored and execution of the program can resume in the interpreter using the unoptimized bytecode derived from the program. Resumption of the program can resume at the point in the bytecode analogous to the point in the optimized compiled code at which the assumption or assumptions was determined to be false.

Optimizations in the optimized compiled code can include optimizations for variable type operations. The amount of bailout information passed to the interpreter can be minimized. Inactive compiled code variables do not need to be resurrected for the interpreter.

One or more bailout points can be set at pre-determined points in the optimized compiled code. At each bailout point, variable location and a corresponding location in the unoptimized bytecode can be captured. When a bailout point is reached during execution, the assumption or assumptions associated with the bailout point can be checked for validity and variable state can be restored for corresponding interpreter variables. The variable state and corresponding location in the unoptimized bytecode can be sent to the interpreter. The interpreter can resume execution of the unoptimized bytecode at the received corresponding location in the unoptimized bytecode.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates an example of a system 100 that includes a browser application configured to render pages from received documents in accordance with aspects of the subject matter disclosed herein;

FIG. 1b illustrates an example of a system 200 comprising a runtime engine configured to transfer execution from compiled code to bytecode in accordance with aspects of the subject matter disclosed herein;

FIG. 1c illustrates an example of a system 300 comprising a runtime engine configured to transfer execution from compiled code to bytecode in accordance with aspects of the subject matter disclosed herein;

FIG. 1d illustrates an example 150 of a program source code, corresponding bytecode, compiled code and bailout tables in accordance with aspects of the subject matter disclosed herein;

FIG. 1e illustrates an example 170 of compiled code with bailout information in accordance with aspects of the subject matter disclosed herein;

FIG. 1f illustrates an example 171 of a program source code, and compiled code with bailout information in accordance with aspects of the subject matter disclosed herein;

FIG. 1g illustrates an example 180 of a program source code, corresponding bytecode, and compiled code with bailout information in accordance with aspects of the subject matter disclosed herein;

FIG. 2 illustrates an example of a method 250 that transfers program execution from optimized compiled code to interpreted code in accordance with aspects of the subject matter disclosed herein;

FIG. 3 is a block diagram of an example of a computing environment in accordance with aspects of the subject matter disclosed herein.

### DETAILED DESCRIPTION

### Overview

Some traditional compiler optimizations based on static analysis are not available for a dynamic language because the information needed to make the optimizations is not available at compile time. Some degree of optimization, however, can be performed by deducing the missing information using heuristics or by collecting and/or using collected profile data or by otherwise making one or more assumptions. For example, suppose a script is received by a runtime engine for execution as part of a web page or other document. The runtime engine may use an interpreter to execute the script. Profile information regarding the script may be collected by the interpreter during execution of the script one or more times. The profile information may be used to determine portions of the script that may be more efficiently executed by compiling the portions using a compiler and executing the resulting machine code rather than interpreting those portions of the script. Thus, some portions of a script can be executed using an interpreter, and other portions of the script can be compiled using a compiler and the generated compiled code can be executed. Compiled portions of the script (e.g., native machine code) can be stored for later use in the event that those portions of the script are executed again.

Similarly, startup portions of the script can be determined. Startup portions of the script can be flagged so that in subsequent runs of the script the startup portions can be processed by the runtime engine before non-startup portions are processed.

In accordance with aspects of the subject matter described herein, compiled bytecode comprising any block of code, such as a method or function or any portion of a method or function can be executed. The compiled bytecode can be optimized based on one or more assumptions about the characteristics of the information that is available at runtime for the program. The assumptions can be based on profile information, heuristics or on any other suitable information. The optimized compiled bytecode can include one or more bailout points that are pre-determined based on the particular optimizations that are made in the compiled bytecode. For each bailout point a set of variables that are holding values needed by the interpreter to resume execution at the bailout point can be captured. A bailout table for each bailout point can be created after register allocation. The bailout table for each bailout point can include the location of each variable (e.g., stack location, register, etc.) for the bailout point. The bailout table can also include the state of each variable (e.g., for the cases in which the variable has been optimized to an int32, double, etc. by type specialization or other optimization).

During subsequent executions of the optimized compiled bytecode, the assumptions about the data the program will operate on, on which the bytecode was generated, can be tested. In response to determining that one or more of the assumptions on which the optimization was made is incorrect, execution can “bailout” to the interpreter. That is, execution of the compiled code can be stopped and the interpreter can execute unoptimized bytecode corresponding to the optimized compiled bytecode starting at the bailout point corresponding to the point in the optimized compiled code at which the assumption or assumptions were determined to be false. When a bailout occurs, the state of the variables needed by the interpreter can be rematerialized by examining the bailout table for the bailout point. The bailout table for the bailout point can provide a value (for constants) or a location for the variable. The bailout table can provide a state (for type specialization) of each variable needed by the interpreter to resume execution at that bailout point. After the state of the variables needed by the interpreter to resume execution is rematerialized, control can be resumed by the interpreter at the bailout location, to carry on the execution of the currently executing function.

In accordance with some aspects of the subject matter described herein, source code coded in a dynamic language can be received for execution. The source code can be any block of code, such as a method or function or any portion of a method or function. The source code can be parsed to generate parsed source code. The parsed source code can be converted to bytecode. The bytecode can be interpreted one or more times using an interpreter. Profile information regarding the usage pattern of the bytecode can be generated. The profile information can be stored. The profile information can be analyzed to determine a condition associated with the received portion of the bytecode. The bytecode portion can be just-in-time (JIT) compiled into a compiled bytecode portion as a result of the determined condition. The compiled bytecode portion can be stored. The bytecode portion can be received again later in bytecode received at the interpreter. The compiled bytecode portion corresponding to the received bytecode portion can be located in storage. At least one condition check can be performed on the compiled bytecode portion located in storage. Instead of interpreting the received bytecode portion, the compiled bytecode portion can be executed if the at least one condition check passes. The compiled bytecode portion can include optimizations based on assumptions. The assumptions can be based on the profile data, on heuristics or on other information provided. When the optimized code is executed, condition checks can be performed. In response to determining that the assumption on which the optimization was based is incorrect, execution of the compiled code can end. Execution of the code can be resumed at a location in the bytecode that is analogous to the point at which the assumption was determined to be false.

In one example of a system implementation, a runtime engine can be provided. The runtime engine can include all or some of the following: a parser, a bytecode generator, an execution controller, an interpreter, a JIT compiler, a profile generator and a bailout engine. The parser can receive source code coded in a dynamic language and can parse the source code to generate parsed source code. The bytecode generator can convert the parsed source code to bytecode. The interpreter can be configured to interpret the bytecode one or more times, when enabled by the execution controller. The JIT compiler can be configured to compile the bytecode when enabled by the execution controller. The profile generator can generate profile information from the bytecode or from the source code and can store the profile information. The execution controller can enable the interpreter or the JIT compiler to perform their respective functions based on the profile information.

Optimizations can then be made in the compiled code. Bailout points can be inserted at pre-determined points in the compiled code. Bailout points can be pre-determined based on the characteristics of particular optimizations. For each bailout point, the set of variables holding values enabling the interpreter to resume execution at that point in the program can be captured. Locations of variables corresponding to the pre-determined bailout points can be stored. In a subsequent program execution, if the deduction on which an optimization is based proves to be incorrect, a fallback or bailout mechanism can be provided. A deduction can be determined to be incorrect by checking conditions associated with the assumption. In accordance with aspects of the subject matter disclosed herein, a machine code executer can check the associated conditions. In response to determining that a deduction is incorrect (e.g., by the machine code executor checking conditions), in accordance with aspects of the subject matter disclosed herein, execution of the compiled code can stop, variables needed by the interpreter can be reset to values saved at a pre-determined bailout point and execution can be resumed at the interpreter. The interpreter can resume execution at the bailout point associated with the incorrect assumption.

In accordance with aspects of the subject matter disclosed herein, the bailout engine can restore the state of the associated active variables by translating the state of the variables associated with the machine code into the state needed for the interpreter. Bailout points can be determined at compilation time (e.g., by the JIT compiler). Bailout points occur wherever there is a path that depends on an assumption that is made. Each bailout point can have a table associated with it that includes information concerning the set of interpreter variables that have to be resurrected in order for the interpreter to execute correctly, a description of how the translation is performed to translate variable values from the values associated with the machine code to the values associated with the interpreter, and the position in the bytecode at which the interpretation resumes.

A variable that is no longer needed and is therefore inactive in the compiled code execution may need to be resurrected for the interpreter. That is, the liveness of one or more variables may need to be extended to the bailout point to make the information held by the variable available to the interpreter. Optimizations can be performed to minimize the impact on the number of registers that are needed. For example, if a variable value is known to be a constant value at a particular bailout point, the constant can be recorded so that the variable no longer needs to be available at that bailout point. Similarly, if a variable is known to contain the same value as another variable at a particular bailout point, only one variable containing the value can be made available to the interpreter at the bailout point.

Transferring Program Execution from Compiled Code to Interpreted Code

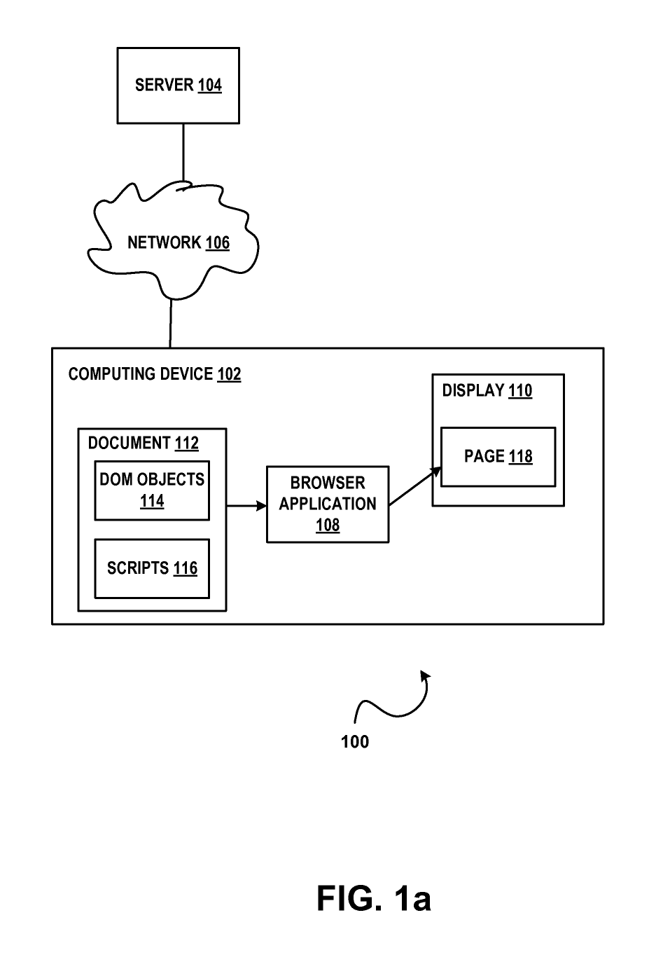

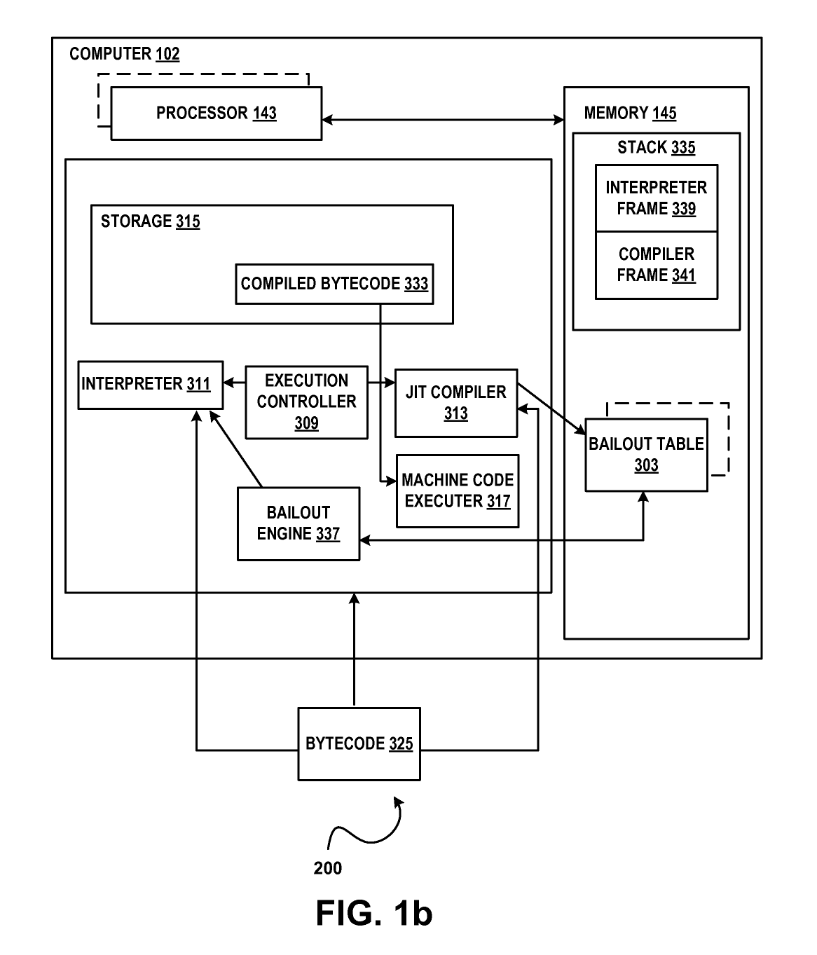

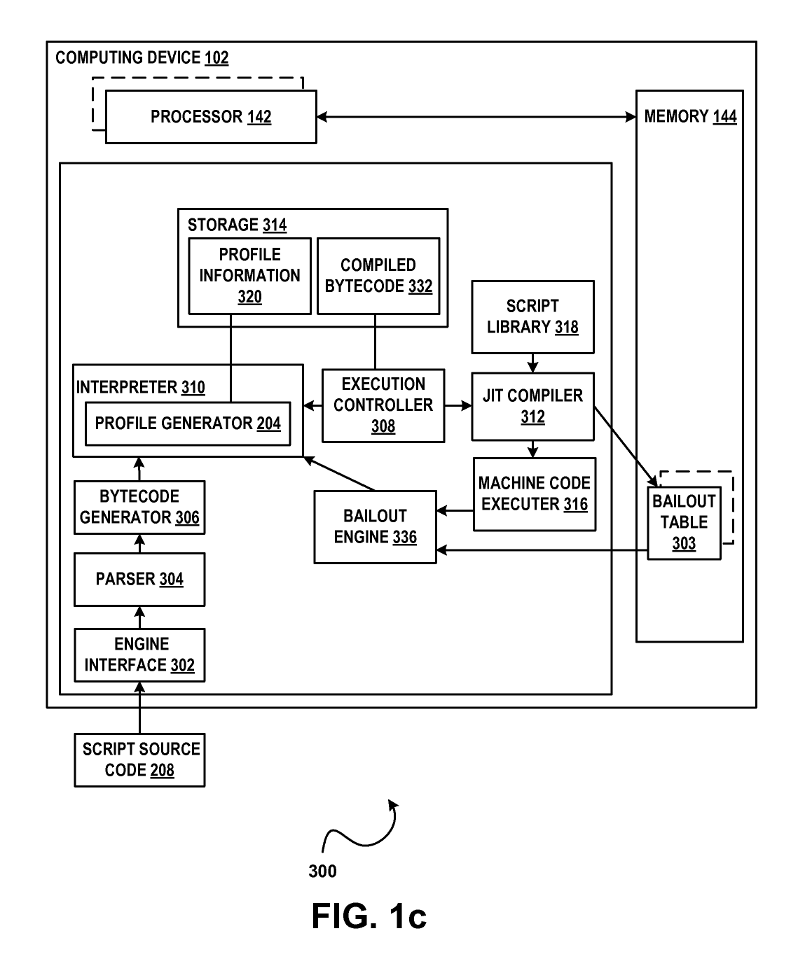

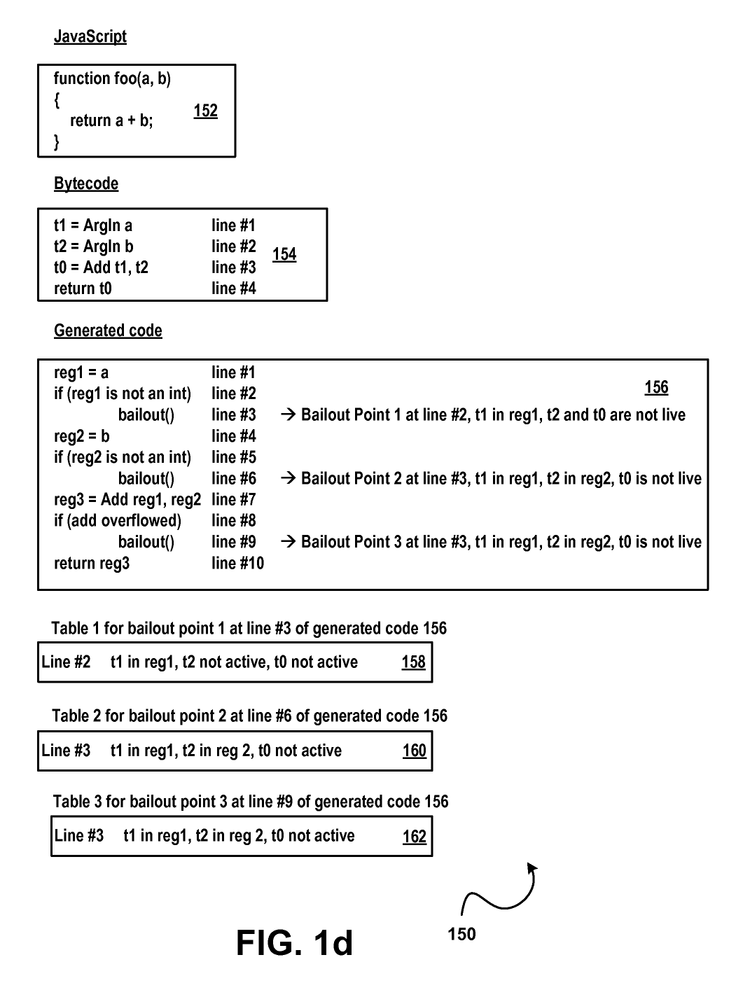

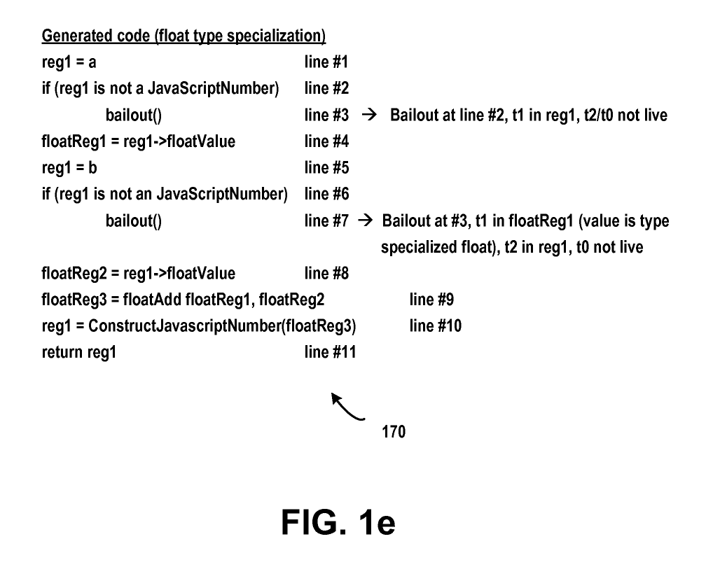

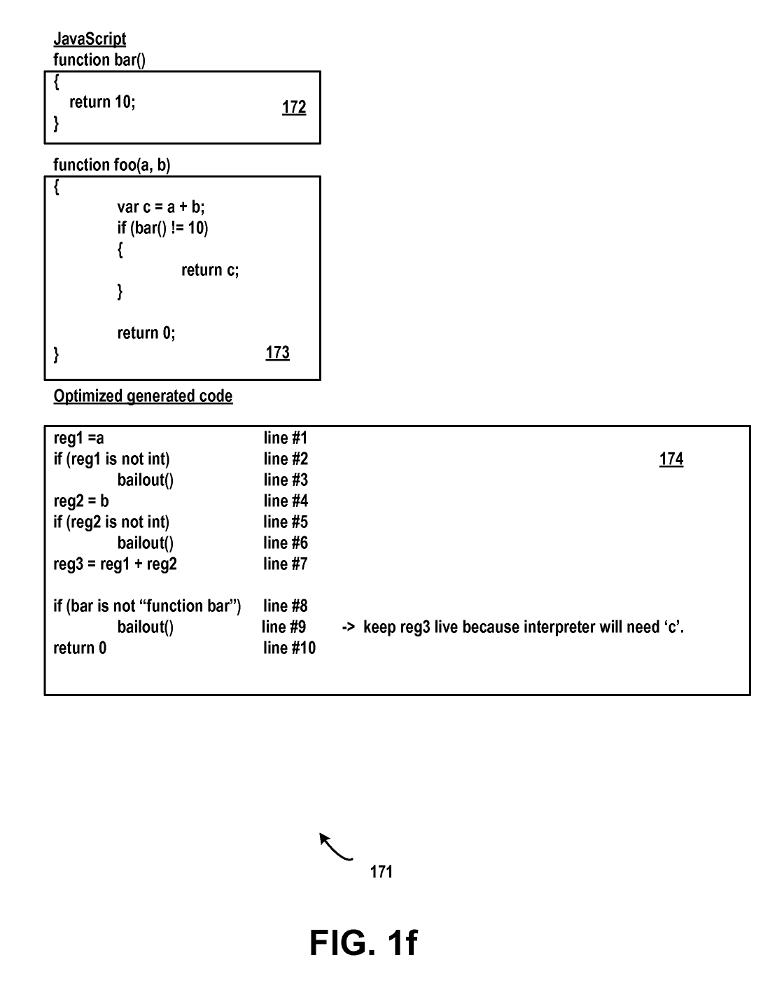

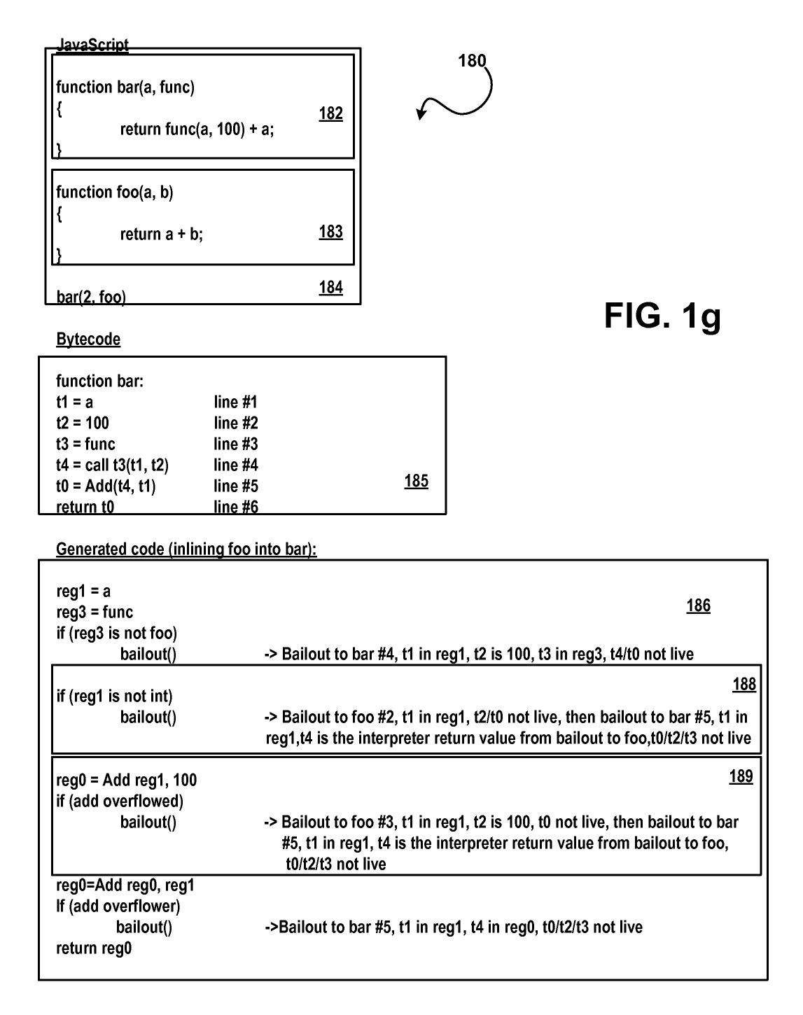

FIG. 1a illustrates a web browsing environment 100, in accordance with some aspects of the subject matter disclosed herein. As shown in FIG. 1a, environment 100 can include one or more of: a computing device 102, a server 104, a network 106 and a browser application 108. Web browsing environment 100 may include other components known in the arts.

Computing device 102 can be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a mobile phone (e.g., a cell phone, a smart phone such as an Apple iPhone, a Google Android™ phone, a Microsoft Windows® phone, etc.), or other type of mobile device. Server 104 may be implemented in one or more computer systems, including one or more servers, which may be any type of computing device described herein or otherwise known that is capable of enabling the corresponding functionality described herein.

Computing device 102 and server 104 can be communicatively coupled by network 106. Network 106 can include one or more communication links and/or communication networks, such as a PAN (personal area network), a LAN (local area network), a WAN (wide area network), or a combination of networks, such as the Internet. Computing device 102 and server 104 may be communicatively coupled to network 106 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

Browser application 108 can be a program that can execute on computing device 102. Browser application 108 can enable network information resources to be retrieved, presented, and traversed. An information resource or object can be retrieved by browser application 108 using a network address, such as a uniform resource identifier (URI). Examples of information resources include web pages, images, videos, and other forms of content. Hyperlinks that are present in information resources enable users easily to navigate their browsers to related resources. Examples of browser application 108 include Internet Explorer, developed by Microsoft Corp. of Redmond, Wash., Mozilla Firefox®, developed by Mozilla Corp. of Mountain View, Calif., Safari®, developed by Apple Inc. of Cupertino, Calif., and Google® Chrome of Mountain View, Calif.

Browser application 108 can retrieve a document 112 from a server 104 through network 106. Document 112 can be a web document that includes code of a markup language, such as Hyper Text Markup Language (HTML), dynamic HTML (DHTML), extensible HTML (XHTML), extensible markup language (XML), etc. Document 112 can include DOM (document object model) objects 114 and one or more scripts 116. DOM objects 114 can include one or more objects represented in document 112 according to the DOM convention, which is a cross-platform and language-independent convention for representing and interacting with objects. DOM objects 114 may include objects that are directly included in document 112, and/or are referenced by document 112 and separately retrieved from server 104 or other server. Script(s) 116 include code formatted according to a dynamic language (e.g., JavaScript, VBScript, AJAX, Python, Perl, etc.) that enables changes to be made to DOM objects 114, including changes based on factors such as user input, environmental conditions (e.g., the time of day, or other variables), etc. The code of script(s) 116 can access and modify objects of DOM objects 114 on the fly without returning to server 104.

Browser application 108 can receive (e.g., load) document 112. Browser application 108 can include a browser engine (e.g., a layout engine or rendering engine) that formats information of document 112, and displays the formatted information. For example, as shown in FIG. 1a, browser application 108 can generate a page 118 based on document 112 that is displayed by a display 110 of computing device 102. Browser application 108 can be configured to execute one or more scripts 116 that are embedded in document 112, or that are separate from but associated with document 112.

FIG. 1b illustrates a block diagram of a system 200, according to some aspects of the subject matter disclosed herein. System 200 can include one or more computers or computing devices such as computing device 102 including one or more processors such as processor 143, etc. memory 145, an execution controller 309, an interpreter 311, a compiler such as a JIT (just-in-time) compiler 313, storage 315, a machine code executer 317, and a bailout engine 337. The execution controller 309, interpreter 311, compiler such as a JIT compiler 313, storage 315, machine code executer 317, and bailout engine 337 can be implemented as one or more program modules which when loaded into memory 145 cause the one or more processors 143, etc. to perform the actions attributed to the execution controller 309, interpreter 311, compiler such as a JIT compiler 313, machine code executer 317, and bailout engine 337, respectively.

The execution controller 309, interpreter 311, and/or JIT compiler 313 can receive bytecode generated from source code. Source code can be any source code written in a dynamic language, such as but not limited to dynamic scripting languages such as but not limited to JavaScript, VBScript, Python and so on. The source code can be parsed and bytecode can be generated from the parsed source code. Based on bytecode 325 and profile, heuristic or other information, execution controller 309 can enable one of interpreter 311 and JIT compiler 313 to operate on bytecode 325. Interpreter 311 can be configured to interpret bytecode 325 when enabled by an interpreter control signal received from execution controller 309. JIT compiler 313 can be configured to compile bytecode 325 when enabled by a compiler control signal received from execution controller 309.

When interpreter 311 is enabled by an interpreter control signal, interpreter 311 can interpret and execute unoptimized bytecode 325. Interpreter 311 can be implemented as a JavaScript interpreter, a VBScript interpreter, a Python interpreter, or as an interpreter for another dynamic language or dynamic scripting language mentioned elsewhere herein or otherwise known. In this manner, the source code can be at least partially executed by operation of the interpreter 311. Similarly, in response to receiving an enabling compiler control signal, JIT compiler 313 can compile bytecode 325. JIT compiler 313 can be implemented as a JavaScript compiler, a VBScript compiler, a Python compiler, or as a compiler for another dynamic language or dynamic scripting language mentioned elsewhere herein or otherwise known. JIT compiler 313 is referred to as a “just in time” compiler, because particular bytecode portions may be compiled by JIT compiler 313 as the compiled bytecode is needed (e.g., is going to be executed imminently) rather than pre-compiling bytecode 325 in its entirety prior to execution. JIT compiler 313 can generate compiled bytecode 333, having the form of machine executable code or instructions.

JIT compiler 313 can perform code optimizations, based on assumptions as described above. JIT compiler 313 can insert one or more pre-determined bailout points in the compiled bytecode it generates. For each bailout point, a bailout table such as bailout table 303, etc. can be created in which the location of variables, a location in the bytecode 325 corresponding to the bailout point location and other information can be recorded. The bailout table 303, etc. can describe where to find variables on the stack or in the register. JIT compiler 313 can generate the one or more bailout tables and can save them with the optimized compiled bytecode (e.g., as machine code). The bailout table can be optimized by avoiding extension of the lifetimes of variables unnecessarily by encoding the information in the bailout table. For example, if it is known that the value of variable x is the constant 10, at bailout time, x=10 can be encoded in the bailout table so that the value 10 does not need to be in memory or in a register to be resurrected. Similarly, when more than one variable has the same value, (e.g., x=y;) at the bailout point the same location can be used in the bailout table for all variables having the same value if this information is encoded in the bailout table (e.g., the same location in the bailout table can be used for x and y).

These techniques can make register allocation more efficient. Optimized compiled bytecode can be stored in storage 315 as compiled bytecode 333 for access during subsequent execution of the program by system 200.

When the optimized compiled bytecode is executed, optimized compiled bytecode 333 can be received by machine code executer 317 (which can be one or more processors such as processor 143, etc.). Executing compiled bytecode can be associated with a compiler frame 341 on stack 335. The underlying assumption or assumptions on which the optimizations were based can be determined to be valid or invalid at each bailout point. In response to determining that the assumption(s) are valid, the optimized compiled code can continue to execute. In response to determining that the assumption(s) are invalid, execution of the optimized compiled code can be stopped. The bailout table for that bailout point can be passed to the bailout engine 337. The bailout engine 337 can restore the state (e.g., value) of variables needed by the interpreter. The bailout engine can create a new frame (e.g., interpreter frame 339) for the stack 335. If a variable needed by the interpreter has become inactive the bailout engine 337 can resurrect a variable by changing the state of the variable from inactive to active. The bailout engine 337 can instantiate an instance of the interpreter 311, pass the interpreter the location in the unoptimized bytecode corresponding to the bailout point in the optimized compiled code and the newly created interpreter frame including the values of all the restored active variables. Hence source code from which the bytecode 325 was generated can thus be partially executed by operation of JIT compiler 313 and machine code executer 317 and partially executed by interpreter 311.

FIG. 1c illustrates another example of a system, system 300 in accordance with aspects of the subject matter disclosed herein. A system 300 can include one or more processors such as processor 142, etc., memory 144, and a runtime engine that includes one or more of the following: an engine interface 302, a parser 304, a bytecode generator 306, an execution controller 308, an interpreter 310, a compiler such as but not limited to a JIT (just-in-time) compiler 312, storage 314, a machine code executer 316, a bailout engine 336 and a script library 318.

As shown in FIG. 1c, engine interface 302 can receive script source code 208. Engine interface 302 can be present or not present. Parser 304 can be configured as an interface to the runtime engine rather than having engine interface 302 present. When present, engine interface 302 can be a communication interface that provides one or more methods for interfacing a host with the runtime engine of FIG. 1c. In accordance with some aspects of the subject matter disclosed herein, engine interface 302 can be implemented according to IActiveScript developed by Microsoft Corporation of Redmond, Wash. Engine interface 302 can provide source code 208 to parser 304.

Parser 304 can receive and parse source code 208. Parser 304 can perform token generation or lexical analysis on source code 208, so that source code 208 is formatted into symbols or tokens. Parser 304 can perform error checking on the tokens to determine whether allowable expressions are formed, that syntax errors are not present, etc. Parser 304 can output the parsed source code as parsed source code (not shown). Parsed source code can have any suitable form, including being generated by parser 304 as AST (abstract syntax tree) code, which includes a tree representation of the abstract syntactic structure of source code 208, as would be known to persons skilled in the relevant art(s).

Bytecode generator 306 can receive the parsed source code. Bytecode generator 306 can be configured to convert the parsed source code into bytecode, which includes instruction sets configured for efficient execution by an interpreter, as well as for further compilation into machine code. Generated bytecode can represent the parsed source code as numeric codes and corresponding optional parameters. Bytecode generator 306 can output the generated bytecode (not shown). The bytecode can have any suitable form, including being generated by bytecode generator 306 in the form of p-code (portable code), as would be known to persons skilled in the relevant art(s).

Execution controller 308, interpreter 310, and JIT compiler 312 can each receive the generated bytecode. Interpreter 310 can include profile generator 204. Profile generator 204 can be configured to analyze the generated bytecode to collect statistics and further information regarding source code 208. Profile generator 204 can generate profile information 320, which can include the collected information, and which can be stored in storage 314.

Execution controller 308 can access profile information 320, and can be communicatively coupled to interpreter 310 and JIT compiler 312. Based on the generated bytecode and profile information 320, execution controller 308 can enable one of interpreter 310 and JIT compiler 312 to operate on the generated bytecode. Interpreter 310 can be configured to interpret the generated bytecode when enabled by an interpreter control signal received from execution controller 308. JIT compiler 312 can be configured to compile the generated bytecode when enabled by a compiler control signal received from execution controller 308. For example, during a first execution of source code 208, profile information 320 may not yet exist. In such a case, execution controller 308 can enable interpreter 310 to interpret the generated bytecode and to generate profile information 320. During a subsequent execution of source code 208 (e.g., later during the same first execution of source code 208, and/or during a subsequent execution of source code 208), execution controller 308 can enable interpreter 310 to interpret portions of source code 208, and can enable JIT compiler 312 to compile other portions of source code 208, based on profile information 320.

When interpreter 310 is enabled by the interpreter control signal, interpreter 310 can interpret and execute the generated bytecode. Interpreter 310 can be implemented as a JavaScript interpreter, a VBScript interpreter, a Python interpreter, or as an interpreter for another dynamic language mentioned elsewhere herein or otherwise known. In this manner, source code 208 may be at least partially executed by operation of interpreter 310.

When JIT compiler 312 is enabled by a compiler control signal, JIT compiler 312 can compile generated bytecode. JIT compiler 312 can be implemented as a JavaScript compiler, a VBScript compiler, a Python compiler, or as a compiler for another dynamic language mentioned elsewhere herein or otherwise known. JIT compiler 312 is referred to as a “just in time” compiler, because particular bytecode portions may be compiled by JIT compiler 312 as the compiled bytecode is needed (e.g., is going to be executed imminently) rather than pre-compiling the bytecode in its entirety prior to execution. JIT compiler 312 can generate compiled bytecode 332, which can have the form of machine executable code or instructions.

JIT compiler 312 can perform code optimizations, based on assumptions as described above. JIT compiler 312 can insert one or more pre-determined bailout points in the compiled bytecode it generates. For each bailout point, a bailout table such as bailout table 303, etc. can be created in which the state of variables can be recorded, a location in the generated bytecode corresponding to the bailout point location. The bailout table can describe where to find variables on the stack or in the register of the machine code. JIT compiler 312 can generate the tables and save them with the optimized compiled bytecode 332 (e.g., machine code). Optimized compiled bytecode 332 can be stored in storage 314 as compiled bytecode 332 for access during subsequent execution of the program by system 300.

When the optimized compiled bytecode is executed, optimized compiled bytecode 332 can be received by machine code executer 316 (which can be one or more processors such as processor 142, etc.). The underlying assumption or assumptions on which the optimizations were based can be checked for validity or invalidity at each bailout point. In response to determining that the assumption(s) are valid, the optimized compiled bytecode 332 can continue to execute. In response to determining that the assumption(s) are invalid, execution of the optimized compiled code can be stopped. The bailout table for that bailout point can be passed to the bailout engine 336. The bailout engine 336 can restore the state (e.g., value) of variables needed by the interpreter. If a variable needed by the interpreter has become inactive the bailout engine 336 can resurrect a variable by changing the state of the variable from inactive to active. The bailout engine 336 can instantiate an instance of the interpreter 310, pass the interpreter the location in the unoptimized bytecode corresponding to the bailout point in the optimized compiled code, the variables and their locations. Hence source code from which the bytecode was generated can thus be partially executed by operation of JIT compiler 312 and machine code executer 316 and can be partially executed by interpreter 310.

Use of bailouts can enable a number of optimizations. A variable in many dynamic programming languages can be a date, a string, an array, an integer, and so on. In some dynamic languages, an object is created for the variable and the location stored in the register and subsequently in the table comprises a pointer to the object. The object itself can store the description of the object and data for the object. Thus if variable a is a string, an object can be created for the string, a pointer to the object can be stored and the object itself can identify that variable a is a string and can specify the string itself (e.g., “Hello World”). One optimization for this schema for the case in which the variable is assumed based on profile data to be an integer is to store the integer itself in the variable instead of the pointer to the object created for the integer, or an encoded value to represent and describe that integer object. One scheme to encode integer objects directly is to use one of the bits of the word to store an indicator that denotes that the value is an integer. Thus in the case of a 32-bit processor, one bit of the 32 bits can indicate that the contents of the other 31 bits represent the integer value or can indicate that the contents of the other 31 bits do not represent the integer value.

FIG. 1d illustrates an example 150 of source code 152 written in JavaScript in which a function foo performs an addition of two variables a and b and returns the result of the addition operation. The bytecode 154 displayed in example 150 is the bytecode generated from source code 152 for this example. In line #1, the first argument (a) is loaded into the interpreter temporary variable t1. At line #2, the second argument (b) is loaded into the interpreter temporary variable t2. At line #3, the contents of temporary variable t1 and the contents of temporary variable t2 are added and placed into interpreter temporary variable t0. At line #4 the contents of temporary variable t0 is returned. The contents of temporary variable t1, temporary variable t2 and temporary variable t0 can be whatever is legal in JavaScript, including a floating point number, an integer, a string and so on.

In FIG. 1d generated code 156 illustrates pseudocode representing the results of compiling the bytecode 154 and optimizing it for integer addition based on profile data. When bytecode 154 is compiled, it is not known what types of variables a and b are. Variable a and/or variable b could be a string, a date, an integer and so on. If variable a and variable b are dates, one kind of addition operation would be performed, if variable a and variable b are strings, a concatenation operation would be in order and if variable a and variable b are floating point numbers floating point addition operation would be called for. If it were reasonable to expect that variable a and variable b are likely to be integers, (e.g., by running the interpreter several times and finding that variable a and variable b are always integers), then an optimistic optimization for the compiled code may perform an integer addition, as illustrated by generated code 156, which is optimized for integer addition. The code is optimized because the amount of code executed is decreased by not providing code paths for the case when variable a and variable b are dates, strings or non-integer numbers.

In line #1 of generated code 156, the first argument (a) is loaded into a register, reg 1. At this point (bailout point #1) the contents of reg 1 is checked to see if the contents of reg 1 is really an integer. In response to determining that the contents of reg 1 is not an integer, (line #2), execution of generated code is stopped and the bailout engine is called (a bailout instruction is executed at line #3 of generated code 156). Execution of the program continues in the interpreter at line #2 of bytecode 154 because line #1 of bytecode 154 has already been performed: the contents of t1 has been placed in reg 1. T2 and t0 are not yet active and do not have to be resurrected. The contents of the table sent to the bailout engine is represented in the contents 158 of Table 1 of FIG. 1d. The contents 158 of Table 1 state that execution for bailout point 1 resumes at line #2 of bytecode 154, that the value of the variable t1 is stored in reg 1 and variables t2 and t0 are not currently live. That means t2 and t0 are not active and do not need to be resurrected.

If instead, the contents of reg1 is an integer, the generated code 156 continues to execute at line #4 of generated code 156. At line #4 argument b is loaded into register reg2. At line #5 of generated code 156 the content of reg 2 is checked to determine if it is an integer or a non-integer. If the contents of reg2 is a non-integer, a bailout instruction is executed at line #6. Execution of the generated code 156 stops and execution resumes in the interpreter at line #3 of bytecode 154. Variables a and b are active. The value of variable a stored in t1 resides in reg1 and the value of variable b stored in t2 resides in reg2. T0 is not live. This information is placed in Table 2 (contents of Table 2 160).

If instead, the contents of reg2 is an integer, the generated code 156 continues to execute at line #7 of generated code 156. The contents of reg1 and reg2 are added and placed in register reg3. At line #7 the result of the addition of reg1 and reg 2 is placed in register reg3. At line #8, if reg3 overflows, a third bailout point is reached. At the third bailout point at line #9, bailout is directed to line#3 of bytecode 154 to redo the operation in a way that does not lose information. The contents of the associated table, Table 3 162 is the same as Table 2. To avoid losing information, the integer values can be converted to floating point numbers and a floating point add can be performed in the interpreter. If instead, reg3 does not overflow, the generated code 156 continues to execute at line #10 of generated code 156 and returns the value in reg3.

In the example above, one bit of the a JavaScript pointer can be set to an indicator value, the indicator value indicating that the remaining 31 bits represent the value of an integer. To perform math operations on the integer, the 31 bits representing the integer can be extracted from the 32-bit register in which the pointer is stored and the operation can be performed. Further math operations can then be performed on the decoded integer value. Once the value or the result of the math operations needs to be stored or passed to a procedure outside the current compilation scope, it can be re-encoded as a JavaScript object pointer, setting the indicator bit back to the indicator value. For example, in accordance with some embodiments of the subject matter described herein, before the return of reg3 at line #10 of generated code 156, the integer type specialization is undone and the value is re-encoded. (For clarity, encoding/decoding steps are not included in the pseudo-code examples.) The table can also capture the information that t1 is in reg 1. Because this information is decoded, it can be re-encoded as a JavaScript value, resetting the indicator bit to indicate that the other 31 bits are not an integer value. Similarly, 64 bit floating point values can be represented as an object, so that for a floating pointer number a in reg1, a check can be made that the contents of reg1 is a floating point number. If so, the floating point data from the JavaScript number is loaded into a floating point register and eventually a new JavaScript number can be created in which to place the results number, placing the pointer to the JavaScript number in the register returned to the caller.

FIG. 1e illustrates an example 170 of compiled code optimized for addition of floating point numbers for the same JavaScript source code, source code 152 of FIG. 1d. Both the source code and the bytecode 154 are the same for example 170 as for example 150, however, for the sake of example 170, it is assumed that it is reasonable to expect that the variables are floating point numbers instead of integers. It will be appreciated that the first bailout point and the corresponding table information for the first bailout point is identical to generated code 156, optimized for integer addition.

At line #1 of example 170, variable a can be loaded into a register, reg1. At line #2 the contents of reg 1 can be checked to determine whether or not the contents of reg1 points to a JavaScript number. In response to determining that the contents of reg1 does not point to a JavaScript number, the bailout engine can be called at line #3. The bailout information stored in the table for this bailout point, bailout point #1, is the same as in the previous example 150. If the contents of reg1 points to a JavaScript number, at line #4, the floating point value can be ascertained from the JavaScript number by using reg1 to access the floating point data from the JavaScript number, and loading the floating point data into a floating point register, floatReg1. Because reg1 is no longer needed, the compiler can reuse reg1 to load variable b at line #5. At line #6, reg1 can be examined to determine if its contents point to a JavaScript number. If it does not, the bailout engine can be called at line #7. At bailout point #2, to resurrect t1, the value of variable a can be ascertained from floatReg1.

The bailout engine can determine that variable a is a floating point number, and can create a JavaScript number object and can place the location of the JavaScript number in t1 to enable the interpreter to start executing from line #3 of bytecode 154 because the interpreter deals with JavaScript objects not floating point values. At this point t2 resides in reg1 and t0 is not live. If instead at line #6, the contents of reg1 does point to a JavaScript number, the floating point value can be ascertained from the JavaScript number by using reg to access the floating point data from the JavaScript number, and the floating point data can be loaded into a floating point register, floatReg2 at line #8. At line #9 the addition of the two floating point numbers can be performed and the result can be stored in floatReg3. A bailout is not needed here because JavaScript defines number arithmetic as being performed by double precision floating point arithmetic, so any floating point overflow would behave as per the JavaScript conventions. Because reg1 is no longer needed, the compiler can reuse reg1 to hold the pointer to the location of the constructed JavaScript number object holding the results of adding the two floating point values at line #10. At line #11, reg1 can be returned to the caller.

Another optimization called in-lining can be applied when a first function (e.g. a function foo) calls a second function (e.g. a function bar). In this case, the code for function bar can be written out in sequential order inside the code of function foo. If a bailout occurs inside the in-lined function, the state for both the calling function and the called function can be restored and the both functions can be run. A table for the called function and a table for the calling function can be created.

When a function call is made in a dynamic language such as JavaScript, the compiler cannot determine what function is being called at compile time. While the script may indicate that the function foo is being called, at runtime the function called foo can change. Thus assumptions cannot be made about what function is being called at compile time. In-lining generates the code of the called function directly inside of the calling function. When the code is executed, a check can be made dynamically that the function that was in-lined is the function that should actually be called. In accordance with aspects of the subject matter disclosed herein, if the function that is being called is not the in-lined function, a call to the bailout engine can be made. In FIG. 1f, example 171, JavaScript function bar 172 and JavaScript function foo 173 are defined. The compiled code is illustrated in compiled code 174.

The compiler can make the following optimizations. The statement var c=a+b; in function foo 173 is unnecessary if bar is called because bar always returns 10. Function foo returns 0 because bar returns a value of 10. But because bar can change, a check can be made to see to see if bar has changed. If bar has changed, a call to the bailout engine can be made. If a call to the bailout is made, the interpreter will need the variable c. To have c available, a+b will be needed. A+b are stored in reg3 so reg 3 cannot be freed for reuse until after the bailout occurs. Thus at times, variables that otherwise would become inactive are maintained in an active state.

In example 180 of FIG. 1g, JavaScript function bar 182 and JavaScript function foo 183 are defined. Function bar 182 has two arguments: variable a and function func. Script 184 calls function bar 182 with a=2 and func=foo. The bytecode generated from script 184 is illustrated in bytecode 185.

The bytecode for function bar 185 places the value of the variable a (2) in t1 at line #1. The constant 100 is placed in t2 at line #2, the function foo is placed in t3 at line #3 and foo is called with the arguments 2 and 100 at line #4. At line #5 the result of calling foo with the arguments 2 and 100 is added to 2 and the result is placed in t0 which is returned. The compiled bytecode for function foo is shown in FIG. 1d generated code 156. The compiled code that in-lines function foo 183 into function bar 182 is illustrated in FIG. 1g generated code 186. Before the first bailout point BarNativeCode is the top frame of the stack. When the bailout engine is called at the first bailout point, a new frame calling the bailout engine will be placed on top of the stack. When the bailout engine creates the stored interpreted frame for foo and starts running it on the interpreter, the top four frames would be the foo restored interpreted frame, the next would be the frame for the bailout engine, the next the frame for Bar NativeCode with foo in-lined and the caller frame). After the restored foo finishes being interpreted, the bailout engine can create the restored interpreted frame for bar and can start running it on the interpreter. The stack from the top down would appear: Bar Restored Interpreted Frame, the frame for the bailout engine, the frame for the Bar NativeCode with foo in-lined and the caller frame. Finally after the restored bar finishes interpretation, the bailout engine can return to the bar native code and the bar native code can return to the caller. At this point the top frame of the stack would be the frame for the caller.

In-line code 188 and in-lined code 189 represent code from function foo that has been in-lined into the function bar in generated code 186. After function foo has been in-lined into the function bar, the function foo can change. The first bailout to the bar function bytecode 185, checks that foo is the correct function. The function is loaded into reg3 and reg3 is checked to see if function is foo. If it is, execution of the compiled code continues. If it is not, execution resumes in the interpreter. The bailout engine is called at the first bailout point and execution resumes at line #4 of function bar 185. This is a simple bailout because execution is occurring outside of the in-lining so after restoring t1, t2 and t3, execution can continue in the interpreter. If the function is foo, execution continues and executes the in-lined code 188. In in-lined code 188 if the contents of reg1 is not an integer, the bailout engine is called at the second bailout point and execution resumes at line #2 in foo (bytecode 154). Because bar is actually being executed, a bailout to line #5 of function bar can be made as well. After foo is finished executing, the result of foo can be placed into t4. A bailout to line #5 of bar can be made, t1 is in reg1 and t4 will contain the interpreter return value from bailout to foo. This information can be encoded into 2 tables which can be chained together so that the two bailouts will occur one after the other. A similar process can be performed in in-lined code 189 upon add overflow. It will be appreciated that as described above, bailouts occur one line at a time and frames are resurrected one frame at a time. When returning to the caller, the frame for the caller is resurrected.

Before the first bailout point BarNativeCode is the top frame of the stack. When the bailout engine is called at the first bailout point, a new frame calling the bailout engine will be placed on top of the stack. When the bailout engine creates the stored interpreted frame for foo and starts running it on the interpreter, the top four frames would be the foo restored interpreted frame, the next would be the frame for the bailout engine, the next the frame for Bar NativeCode with foo in-lined). After the restored foo finishes being interpreted, the bailout engine can create the restored interpreted frame for bar and can start running it on the interpreter. The stack from the top down would appear Bar Restored Interpreted Frame, the frame for the bailout engine, the frame for the Bar NativeCode with foo in-lined and the caller frame. Finally after the restored bar finishes interpretation, the bailout engine can return to the bar native code and the bar native code can return to the caller. At this point the top frame of the stack would be the frame for the caller.

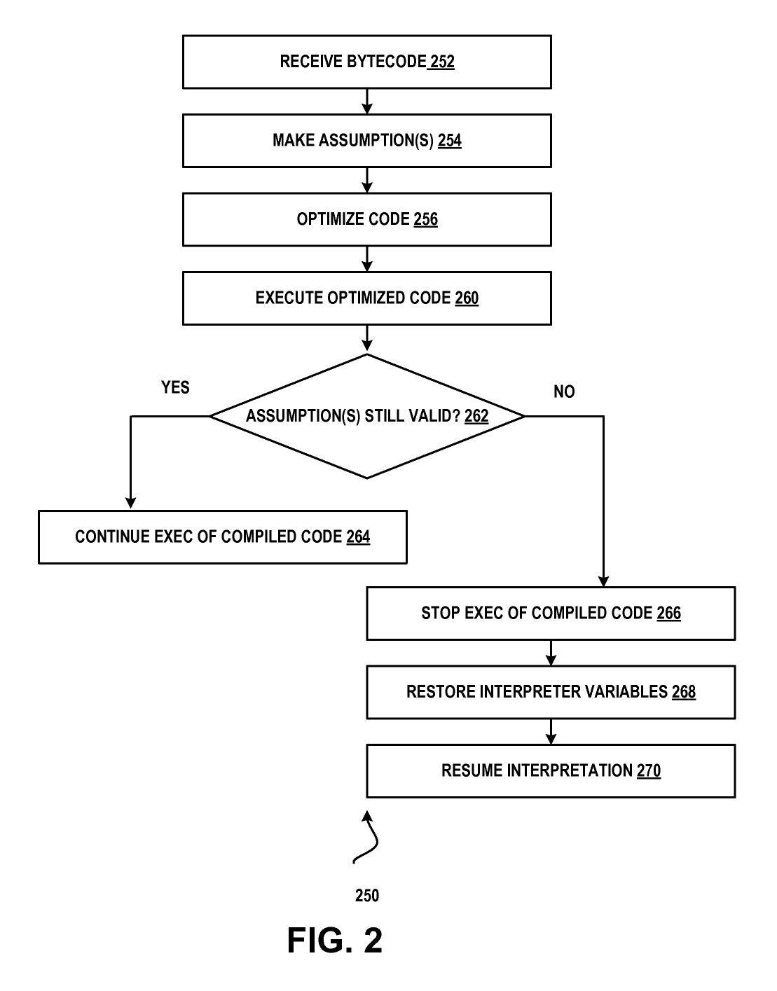

FIG. 2 illustrates a method 250 that can transfer execution of a program written in a dynamic language from compiled code to interpreted code. Method 250 can be implemented by a system such as system 100, system 200 and/or system 300 described above. The sequence described is optional. Not all actions may be taken. At 252 bytecode can be received by a processor of a computing device. At 254 one or more assumptions can be made about the data that the program can operate on. At 256 based on the assumption, optimized compiled code can be generated for a portion of the received bytecode based on the one or more assumptions. Variable value locations can be captured at pre-set bailout points. Corresponding locations in the bytecode can also be captured. At 260 the optimized compiled code can be executed. Variable values can be saved in the variable value locations. At 262 the assumption on which the optimization in the compiled code were based can be checked for validity. At 264 in response to determining that the assumption is still valid, execution of the compiled code can continue. At 266 in response to determining that the assumption is not valid, execution of the compiled code can stop at a bailout point. At 268 the variable values from the captured locations can be used to restore interpreter variable values. At 270 interpretation of bytecode at the indicated analogous location in the bytecode can commence.

### Example of a Suitable Computing Environment

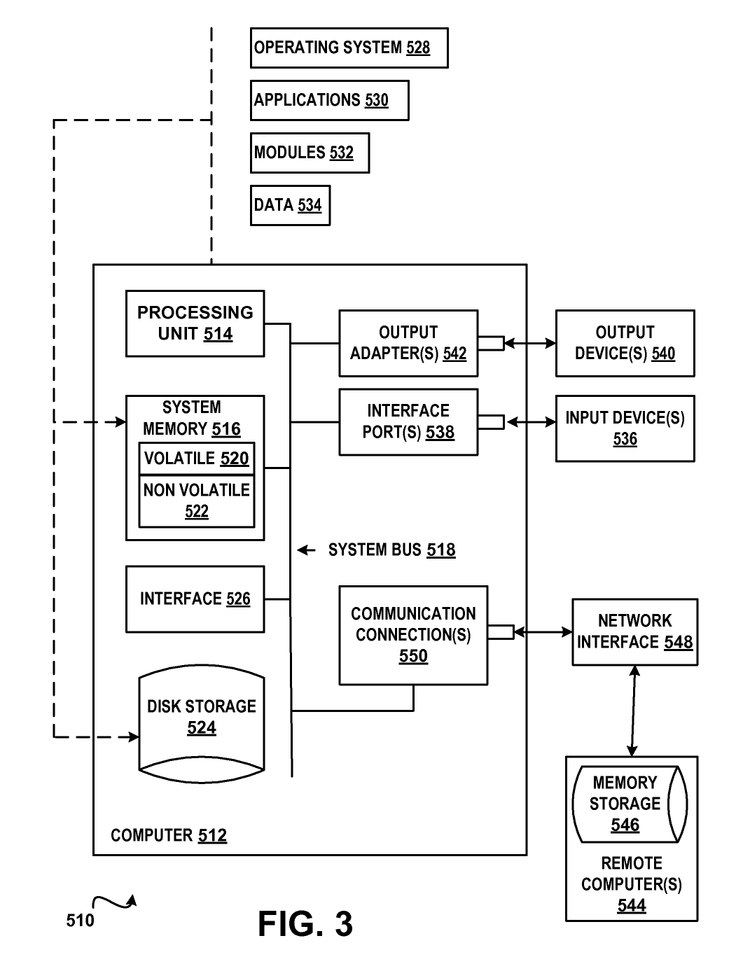

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a GPU. The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer storage media may be implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other transitory or non-transitory medium which can be used to store the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor of a computing device;
a memory of the computing device; and
a bailout engine comprising at least one module loaded into the memory causing the at least one processor to:
in response to detecting invalidity of at least one assumption about characteristics of data on which a program operates, transfer execution of the program written in a dynamic language, from a machine code executer executing compiled code, the compiled code optimized based on the at least one assumption, to interpreted bytecode interpreted by an interpreter, the interpreted bytecode not optimized based on the at least one assumption;
resume execution of the program in the interpreter at a point in the interpreted bytecode corresponding to a point at which the invalidity was detected in the optimized compiled code.

2. The system of claim 1, further comprising:
at least one module loaded into the memory causing the at least one processor to:
rematerialize variables used by the interpreter from corresponding variables used by the machine executer.

3. The system of claim 1, further comprising:
at least one module loaded into the memory causing the at least one processor to:
minimize information transferred to the interpreter by not transferring inactive variables.

4. The system of claim 1, further comprising:
at least one module loaded into the memory causing the at least one processor to:
minimize number of active variables by storing values of the active variables.

5. The system of claim 4, further comprising:
at least one module loaded into the memory causing the at least one processor to:
resurrect variables used by the interpreter.

6. The system of claim 1, further comprising:
at least one module loaded into the memory causing the at least one processor to:
insert at least one bailout point in the optimized compiled bytecode, the at least one bailout point associated with a set of variables holding values needed by the interpreter to resume execution of the program.

7. The system of claim 1, wherein execution is transferred from optimized compiled code to unoptimized bytecode at pre-determined bailout points in the optimized compiled code.

8. A method comprising:
receiving bytecode at the processor of a computing device, the received bytecode comprising unoptimized bytecode derived from a program written in a dynamic language;
receiving at least one assumption concerning data operated on by the program;
generating optimized compiled code based on the at least one assumption;
executing the optimized compiled code;
in response to determining invalidity of the at least one assumption, stopping execution of the optimized compiled code;
restoring interpreter variables corresponding to variables associated with the optimized compiled code;
resuming execution of the program in an interpreter at a point in the unoptimized bytecode corresponding to a point in the optimized compiled code at which the invalidity was determined.

9. The method of claim 8, further comprising:
inserting at least one pre-determined bailout point in the optimized compiled code.

10. The method of claim 9, further comprising:
capturing a location in the unoptimized bytecode corresponding to the at least one pre-determined bailout point in the optimized compiled code.

11. The method of claim 10, further comprising:
capturing location of variables associated with the at least one pre-determined bailout point in the optimized compiled code.

12. The method of claim 11, further comprising:
executing the optimized compiled code;
rematerializing corresponding interpreter variables associated with the optimized compiled code variables at the at least one pre-determined bailout point.

13. The method of claim 8, further comprising:
minimizing bailout information transferred from execution of the optimized compiled code to interpretation of the unoptimized bytecode.

14. The method of claim 8, further comprising:
resurrecting variables used by the interpreter.

15. A computer-readable storage medium comprising computer-executable instructions which when executed cause at least one processor of a computing device to:
in response to detecting at least one invalid condition at a bailout point, bailout from executing optimized compiled code derived from a program written in a dynamic language, the optimized compiled code optimized based on the at least one invalid assumption;
restore state of interpreter variables based on state of the optimized compiled code variables; and
resume execution of the program in the interpreter at a point in unoptimized bytecode corresponding to the bailout point in the optimized compiled code.

16. The computer-readable storage medium of claim 15, comprising further computer-executable instructions, which when executed cause at least one processor to:
execute optimized compiled code derived from the program, the program written in JavaScript.

17. The computer-readable storage medium of claim 15, comprising further computer-executable instructions, which when executed cause at least one processor to:
save bailout information comprising locations at which variables are stored during execution of the optimized compiled program.

18. The computer-readable storage medium of claim 15, comprising further computer-executable instructions, which when executed cause at least one processor to:
save a location in unoptimized bytecode derived from the program corresponding to a pre-determined bailout point in the optimized compiled code derived from the program.

19. The computer-readable storage medium of claim 15, comprising further computer-executable instructions, which when executed cause at least one processor to:
minimizing bailout information by not transferring inactive variables, storing constants instead of pointers, or storing one variable when a plurality of variables have an identical value.

20. The computer-readable storage medium of claim 15, comprising further computer-executable instructions, which when executed cause at least one processor to:
resurrect variables used by the interpreter.
